(19) United States
(12) Patent Application Publication
(10) Pub. No.: US 2014/0101892 A1
(43) Pub. Date: Apr. 17, 2014

(54) HANDLE DEVICE

(71) Applicant: BEL-ART PRODUCTS, WAYNE, NJ (US)

(72) Inventor: Miguel A. Puig, Sterling Forest, NY (US)

(73) Assignee: BEL-ART PRODUCTS, WAYNE, NJ (US)

(21) Appl. No.: 14/048,648

(22) Filed: Oct. 8, 2013

Related U.S. Application Data
(60) Provisional application No. 61/713,266, filed on Oct. 12, 2012.

(51) Int. Cl. B25G 1/10

(52) U.S. Cl. CPC B25G 1/102
USPC 16/430; 29/428

(57) ABSTRACT

The present invention provides a handle device. The handle device includes a hollow body having an outer surface and an inner surface forming a cavity. A slot is formed within the cavity and at least one opening is formed at one end of the body for an insertion of a handle portion of an object. In one embodiment of the present invention, the opening is a modified T-structure of a substantially elongated shape including two tabs located in a center portion of the modified T-structure. The two tabs are substantially perpendicular to the elongated shape of the opening. In another embodiment, the opening is a modified star structure including a central aperture and four sides of a substantially elongated shape extending from the central aperture.

### RELATED APPLICATIONS

This application claims the benefit of U.S. Provisional Application Ser. No. 61/713,266 filed Oct. 12, 2012, entitled, “Handle Device”, the entire content of which is incorporated herein by reference.

### FIELD OF THE INVENTION

The present invention relates to handle devices, and more particularly, to a handle device adapted to securely accommodate and lock an object such as utensil, tool or an instrument.

### BACKGROUND OF THE INVENTION

Handle devices for enhancing the ability of a person to hold and grip an object, tool, or implement are well known in the art. Such devices are typically used by people who have limited dexterity or strength. Among such individuals are persons with arthritis or someone who has suffered injury to the hands, or someone born with a physical disability. These types of devices are also used by children, particularly as they learn to use table utensils, and by other persons to facilitate the holding of many kinds of objects.

Many such handle devices that exist today that are comfortable and easy to hold in order to meet the needs of children and other individuals having physical or motor skill disabilities. However, these handle devices are not adaptable to easily accommodate and secure the objects. As such, the object tends to move inside the handle device and it can be easily removed from the handle device, hence causing a danger to the children and other individuals with physical disabilities. Thus, there is a need in the art to provide a handle device that not only accommodates the object but also firmly secures and locks the object in order to prevent any movement in the object inside the handle device. There is also a need in the art to provide a handle device that prevents the object to be easily removed from the handle device.

### SUMMARY OF THE INVENTION

The present invention provides a handle device and methods of using the same. The handle device is adapted to securely accommodate and lock an object such as a utensil, tool or an instrument.

According to one aspect of the invention, there is provided a handle device, which includes a substantially hollow cylindrical body having an outer surface and an inner surface forming a cavity. A slot is formed within the cavity and at least one opening is formed at one end of the body for an insertion of an object.

In one embodiment, the opening is a modified T-structure of a substantially elongated shape including two tabs located in a center portion of the modified T-structure. The two tabs are substantially perpendicular to the elongated shape of the opening.

In another embodiment, the opening is a modified star structure including a central aperture and four sides of a substantially elongated shape extending from the central aperture.

In a further embodiment, a first opening is formed at a first end of the body and a second opening is formed at a second end (opposite to the first end) of the body.

In some embodiments, the first opening is a modified T-structure of a substantially elongated shape including two tabs located in a center portion of the modified T-structure. The two tabs are substantially perpendicular to the elongated shape of the first opening.

In other embodiments, the second opening is a modified T-structure of a substantially elongated shape including two tabs located in a center portion of the modified T-structure. The two tabs are substantially perpendicular to the elongated shape of the second opening.

### BRIEF DESCRIPTION OF THE DRAWINGS

The present invention will be more readily understood from the detailed description of exemplary embodiments presented below considered in conjunction with the attached drawings, of which:

FIG. 1 is a schematic view of a handle device illustrating a first opening in accordance with one embodiment of the present application;

FIG. 1A is a schematic view of the handle device of FIG. 1 illustrating a second opening in accordance with the embodiment of the present application;

FIG. 2 is a schematic view of an inside surface of the handle device of FIG. 1 in accordance with the embodiment of the present application;

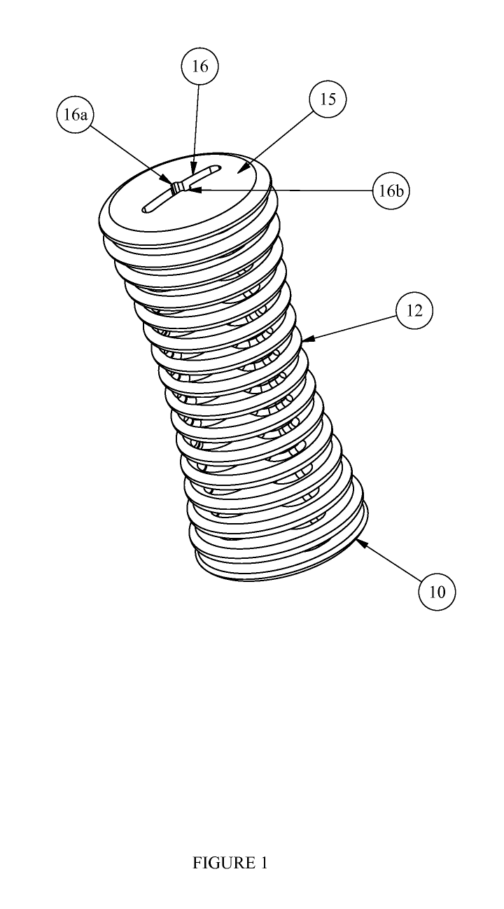

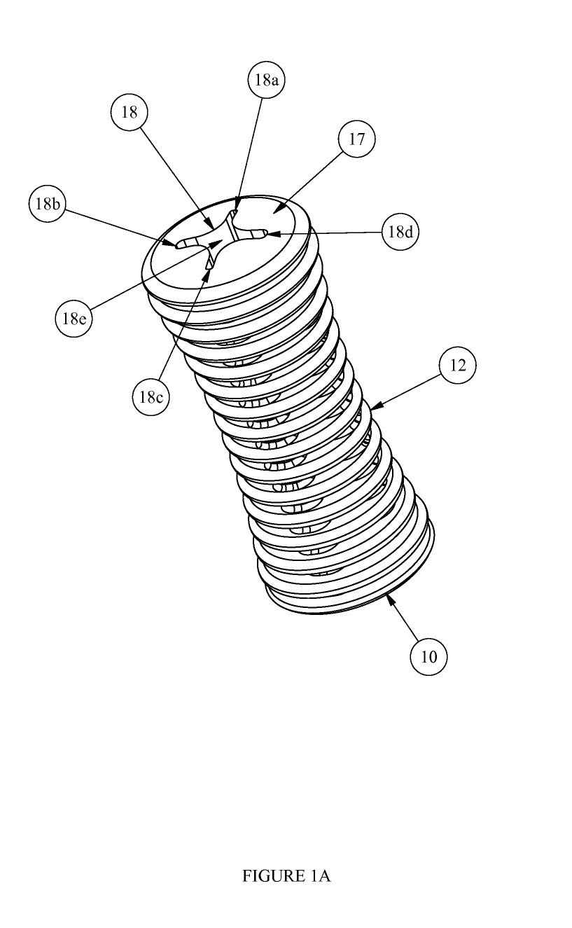

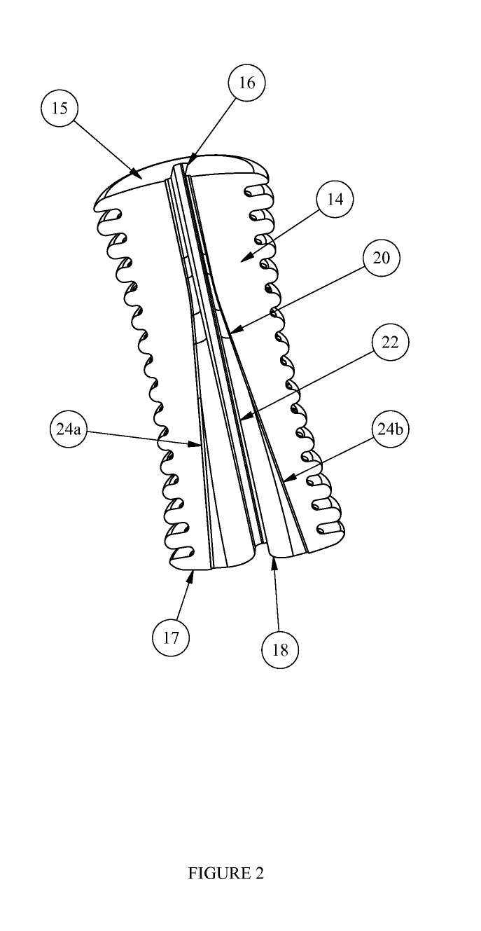

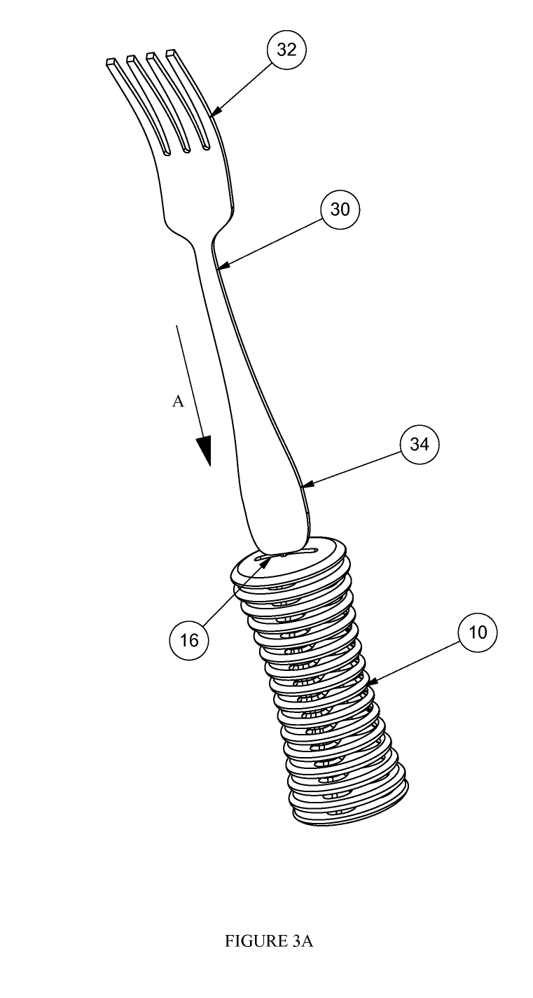

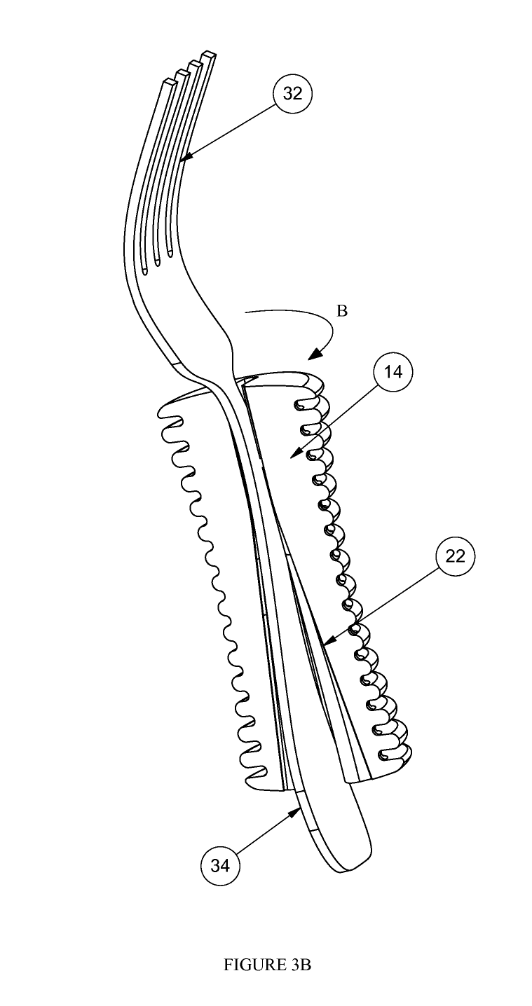

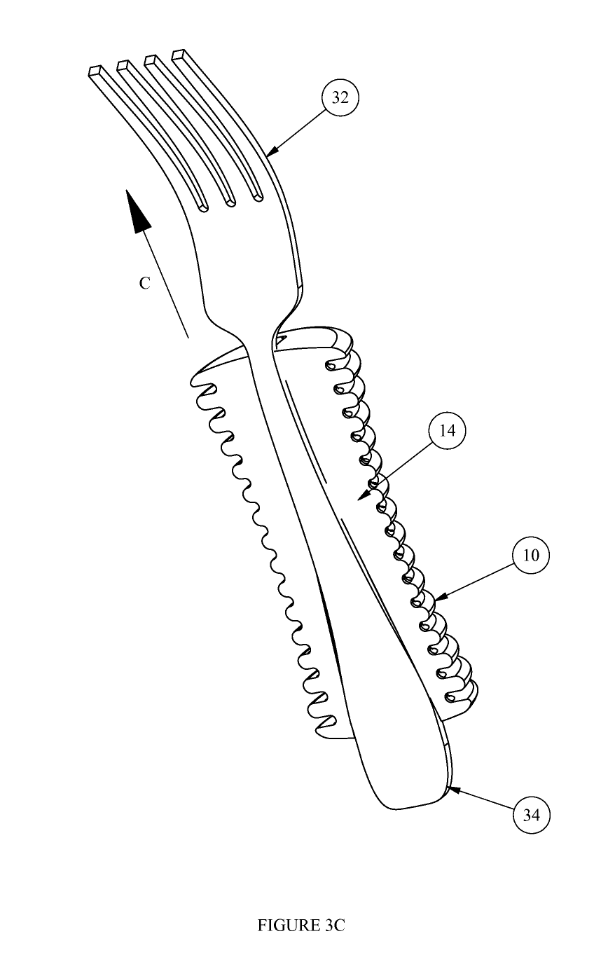

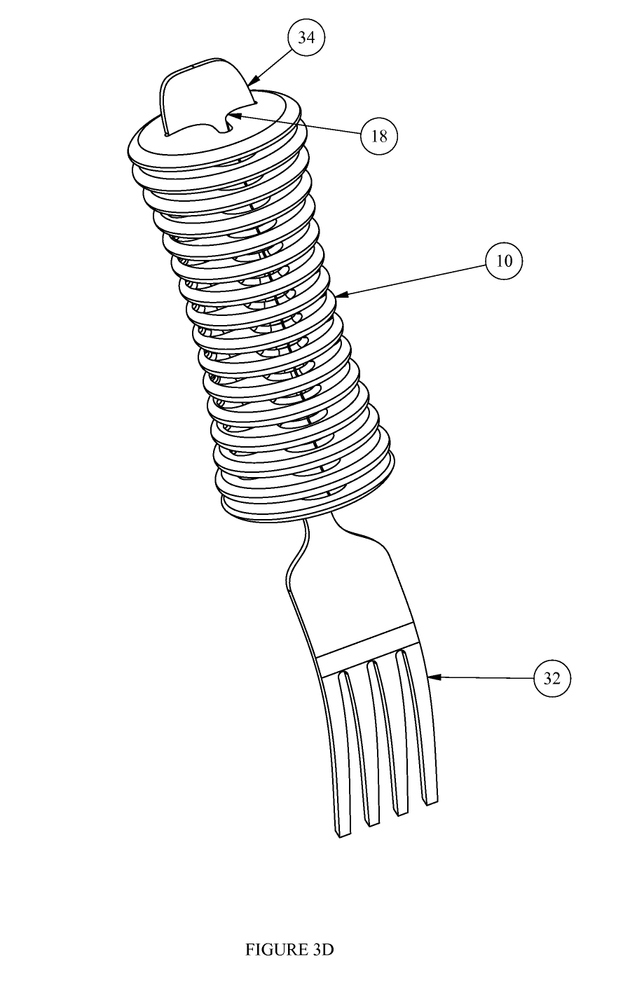

FIG. 1 is a top perspective view of a handle device in accordance with one embodiment of the present application;

FIG. 1A is bottom perspective view of the handle device of FIG. 1 in accordance with the embodiment of the present application;

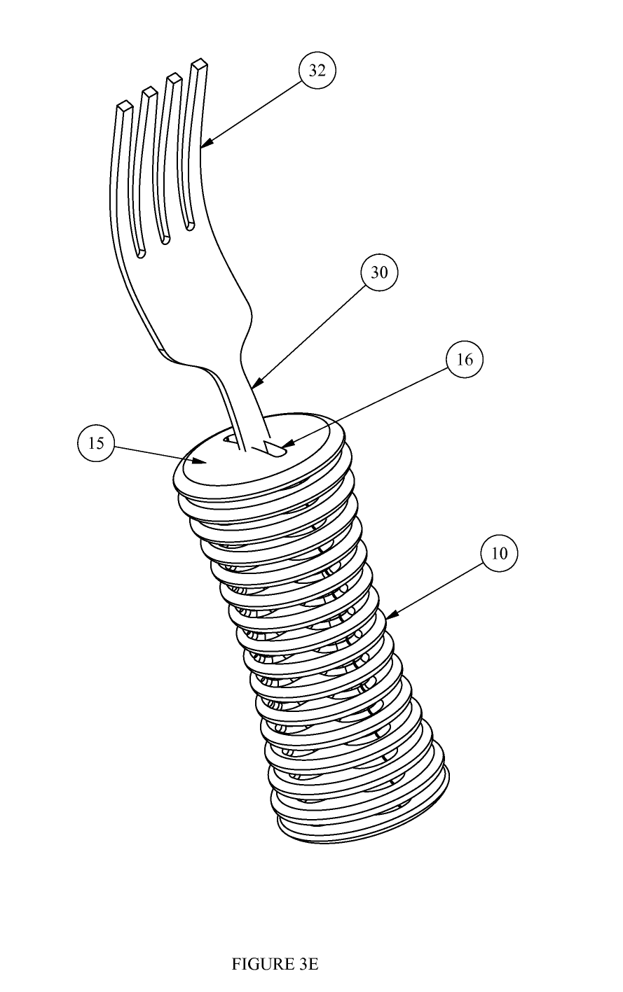

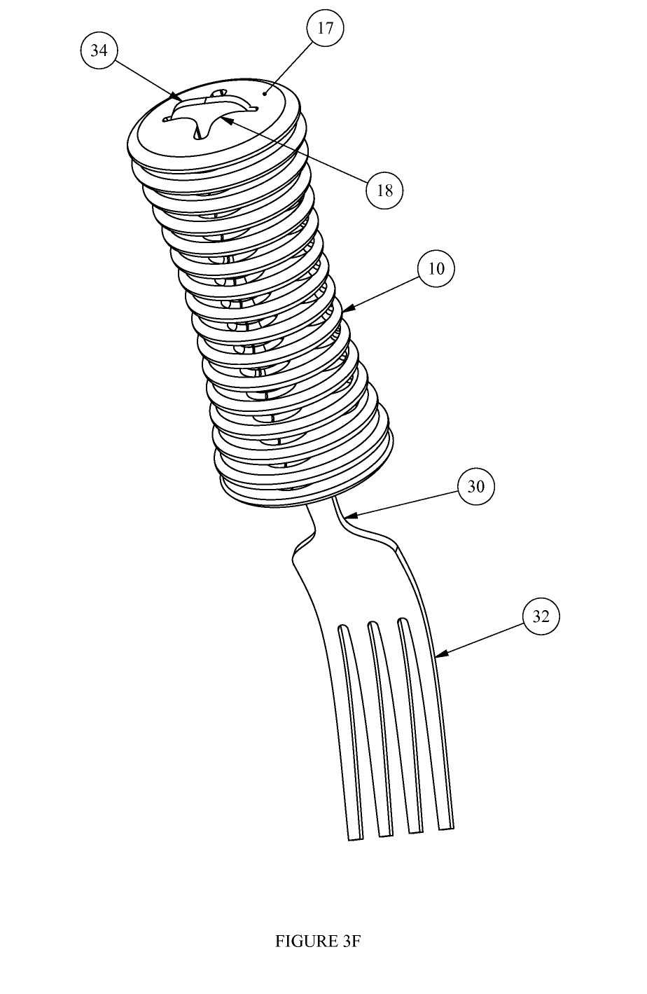

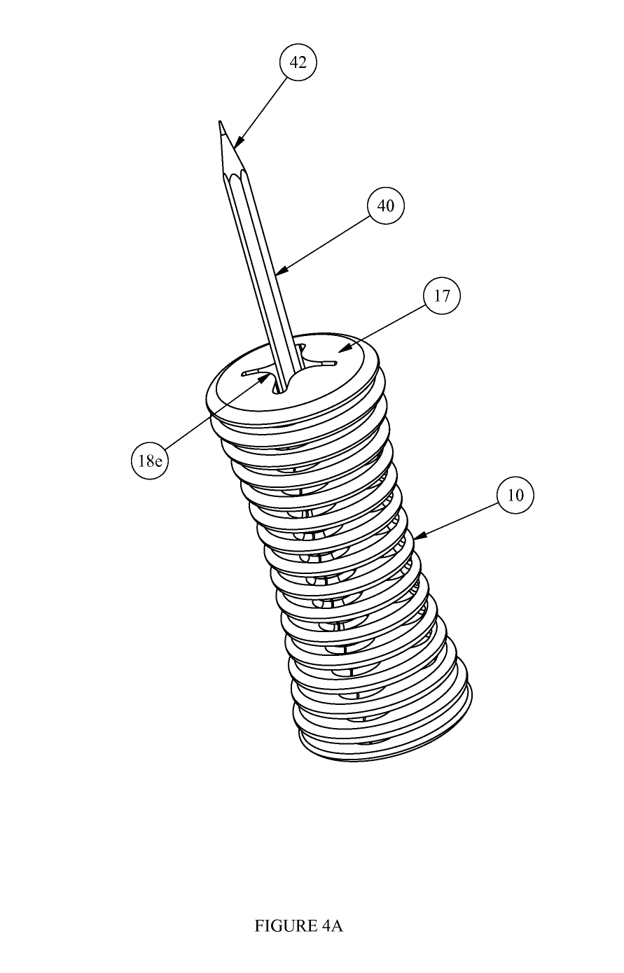

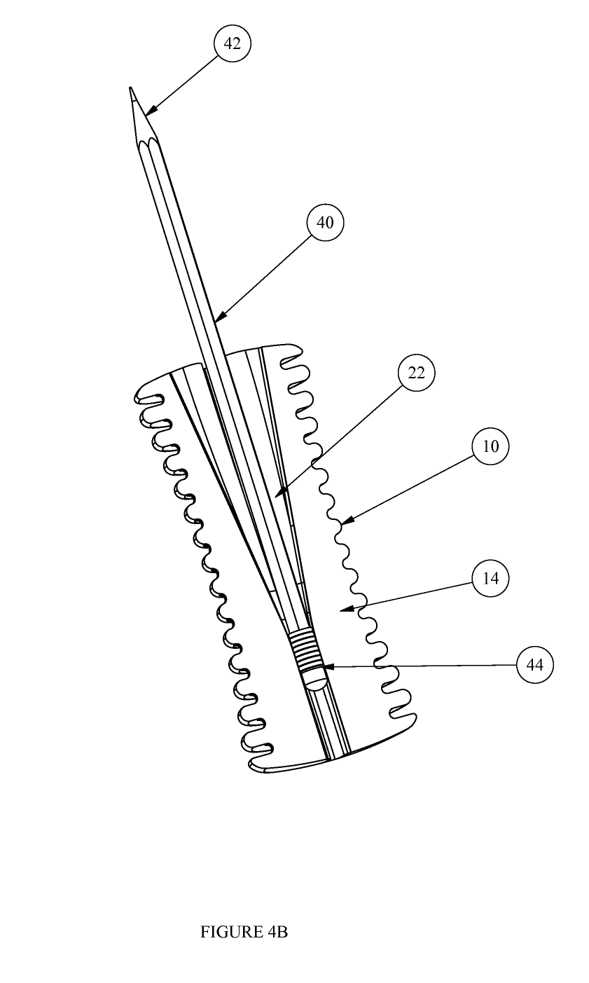

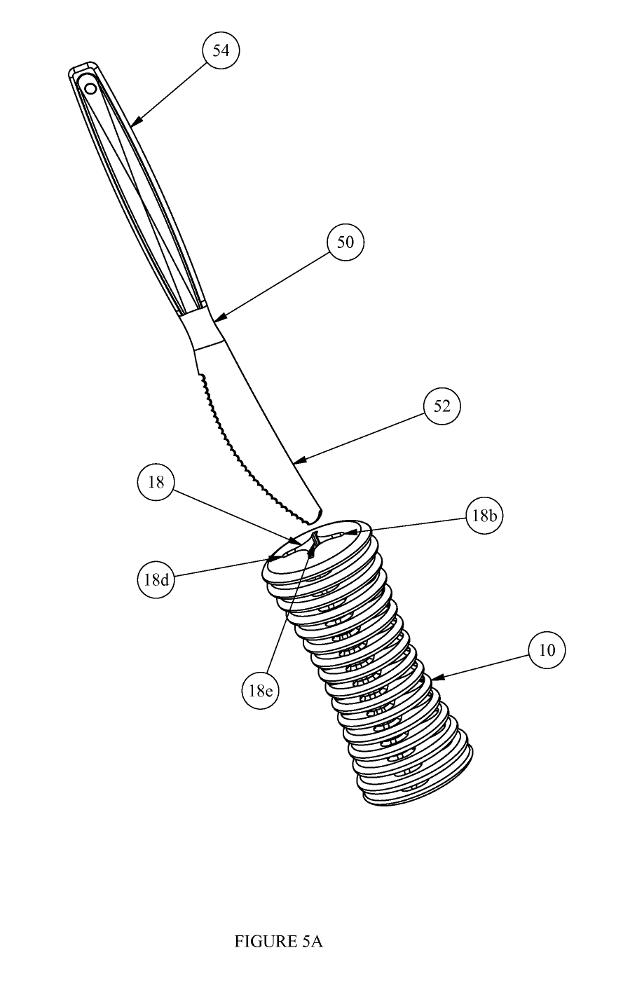

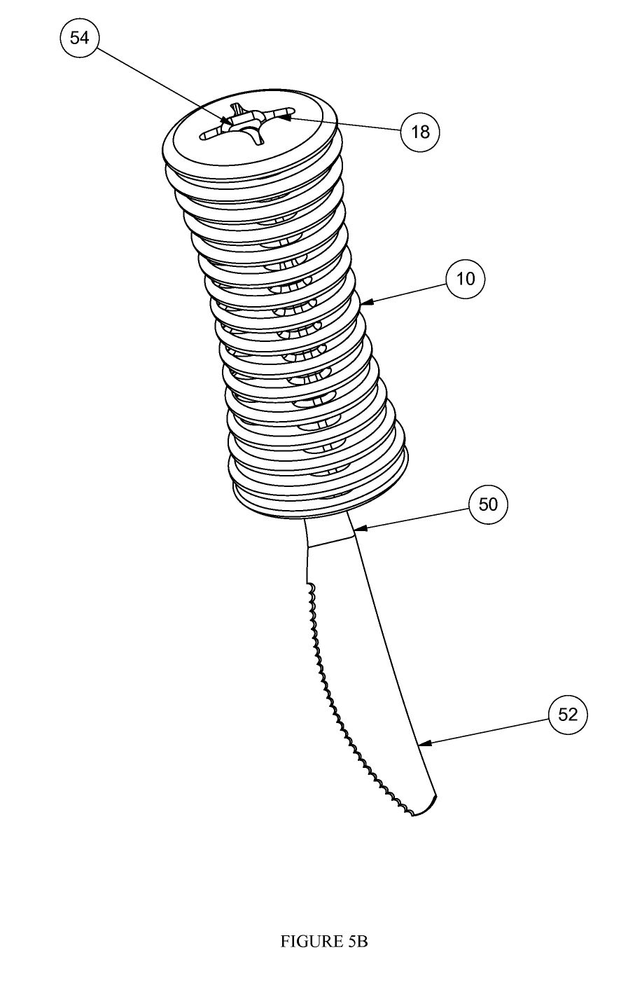

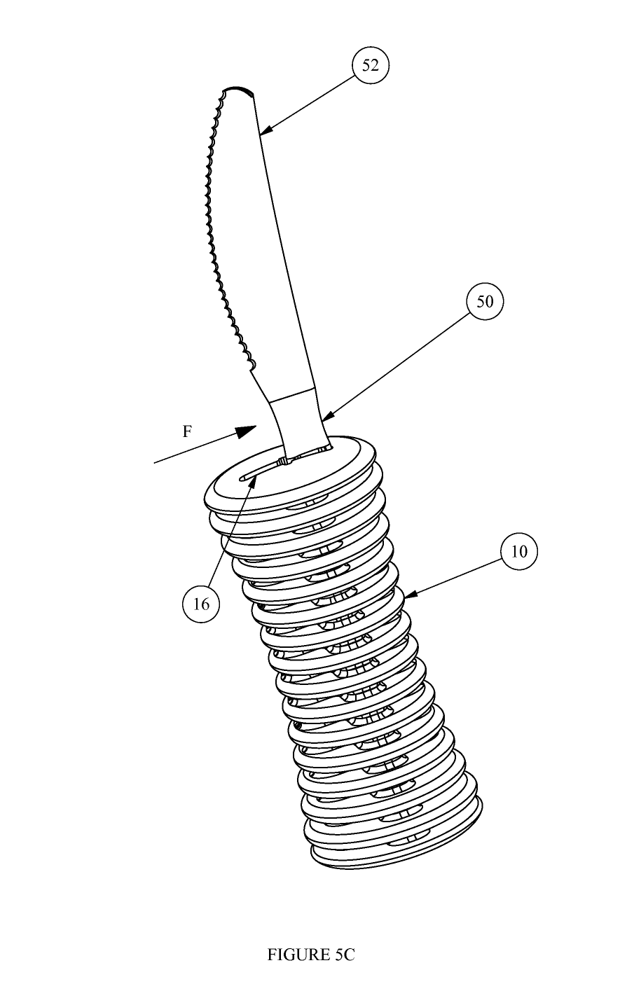

FIG. 2 is a cross section view of an inside portion of the handle device of FIG. 1 in accordance with the embodiment of the present application;

FIG. 3A is a schematic view of a utensil being inserted into the handle device of FIG. 1 in accordance with an another embodiment of the present application;

FIG. 3B is a schematic view of the utensil placed within the inside portion of the handle device of FIG. 1 in accordance with the another embodiment of the present application;

FIG. 3C is a schematic view of the utensil locked within the inside portion of the handle device of FIG. 1 in accordance with the another embodiment of the present application;

FIG. 3D is a schematic view of the utensil firmly secured within the inside portion of the handle device of FIG. 1 in accordance with the another embodiment of the present application;

FIG. 3E is a schematic top view of the handle device of FIG. 1 including the utensil in accordance with the another embodiment of the present application;

FIG. 3F is a schematic bottom view of the handle device of FIG. 1 including the utensil in accordance with the another embodiment of the present application;

FIG. 4A is a top perspective view of an instrument inserted into the handle device of FIG. 1 in accordance with an alternate embodiment of the present application;

FIG. 4B is a schematic view of the instrument securely placed within the inside portion of the handle device of FIG. 1.

FIG. 5A is a top perspective view of a utensil being inserted into the handle device of FIG. 1 in accordance with a further embodiment of the present application;

FIG. 5B is a bottom perspective view of the utensil inserted into the handle device of FIG. 1 in accordance with the further embodiment of the present application;

FIG. 5C is a top perspective view of the utensil being slidable in the handle device of FIG. 1 in accordance with the further embodiment of the present application.

It is noted that the drawings are intended to depict only typical or exemplary embodiments of the invention and thus may not be necessarily to scale. Accordingly, the drawings should not be considered as limiting the scope of the invention. The invention will now be described in detail with reference to the accompanying drawings.

### DETAILED DESCRIPTION OF THE INVENTION

Referring to FIGS. 1, 1A and 2, there is shown a handle device 10 in accordance with an embodiment of the present invention. In one embodiment, the handle device 10 may have substantially hollow cylindrical body preferably made of elastomeric or polymeric material or combinations of both materials. The handle device 10 has an outer surface 12 and an inner surface 14. The handle device 10 includes a first end 15 having a first opening 16 and a second end 17, opposite the first end 13, having a second opening 18. Both the first and the second openings 16 and 18 are shaped and sized to accommodate an object such as a utensil, a tool or an instrument.

In one embodiment, as illustrated in FIG. 1, the first opening 16 is a modified T-structure having substantially elongated shape with two tabs 16a and 16b in a center portion of the opening 16. As shown, the two tabs 16a and 16b are substantially perpendicular to the elongated shaped of the first opening 16. Accordingly, the first opening 16 is shaped and sized to receive and lock an object within the inner surface of 14 of the handle device. In one embodiment, the first opening 16 receives and locks a handle of the object. As one example, the handle has a substantially flat shape.

Referring to FIG. 1A, there is shown a bottom perspective view of the handle device of FIG. 1. As illustrated in FIG. 1A, the second opening 18 is modified star structure having four sides 18a, 18b 18c and 18d and a central opening/aperture 18e. Each of the four sides 18a, 18b, 18c and 18d have a substantially elongate shape and stretch outwards from the central opening/aperture 18e. Specifically, the sides 18a and 18c of the opening 18 are substantially perpendicular to the sides 18b and 18d of the opening 18. Accordingly, the second opening 18 of the handle device 10 is shaped and sized to receive the object. In one embodiment, the second opening 18 receives a handle of the object. In one example, the handle of the object is of substantially round shape. In another example, the handle of the object is of substantially flat shape.

Referring to FIG. 2, there is shown a cross-section of the inner surface 14 of the handle device 10. As shown, the inner surface 14 includes a cavity 20 extending from the first end 15 to the second end 17. A slot 22 is formed inside the cavity. As shown, slot 22 expands from the first end 15 to the second end 17 such that opening in the slot 22 at the first end 15 is narrower than the opening in the slot 22 at the second end 17. As such, the slot 22 forms two angles 24a and 24b of approximately 15 degrees within the inner surface 14 of the handle device 10. In one embodiment, dimensions of the slot 22 are substantially similar to dimensions of the dimensions of the handle of the object such as a tool or instrument. As such, the slot 22 provides for secure placement of the object.

In one embodiment, the sides 18b and 18d of the second opening 18 are parallel to the substantially elongated first opening 16 of the handle device 10. In one embodiment, an object received at the first opening 16 may be pushed inside the cavity 20 and pulled out from the sides 18b and 18d of the second opening 18. Similarly, an object that may be received at the second opening 18 is pushed inside the cavity 20 via the sides 18b and 18d and pulled out from the first opening 16.

The operation of the handle device 10 will now be described with reference to FIGS. 3-5.

In one embodiment, FIG. 3A shows the orientation of the handle device 10 relative to a utensil 30 just prior to the attachment. Although, the utensil 30 is shown to be a fork, one of ordinary skill would appreciate that other utensils such as spoon, knife, spatula, turner, paintbrush or other utensils, tools or instruments that have a substantially flat handle may be used as the utensil 30 of the present invention. A typical utensil 30 such as the fork has two or more prongs 32 with an elongated handle portion 34 having a flat blade like shape. In order to attach the utensil 30 to the handle device 10, utensil 30 is aligned with the handle device 10 and the handle portion 34 is inserted into the first opening 16 of the handle device 10 in the direction of arrow A as shown in FIG. 3A. It should be understood that the utensil 30 is inserted into the first opening 16 such that lower part of the handle portion 34 is placed at the inner surface 14 of the handle device as will be described in detail below.

As shown in FIG. 3B, the handle portion 34 slides into the cavity 20 of the handle device 10. The utensil 30 may easily be removed from the handle device 10 by simply pulling onto the prongs 32 of the utensil. Also, as shown, the utensil 30 is rotated approximately 90 degrees (e.g. in the direction of the arrow B) such that an upper part of the handle portion 34 fits securely into the tabs 16a and 16b of the first opening 16 and a lower part of the handle portion 34 fits securely into the slot 22 as shown in FIG. 3C. Accordingly, the handle portion 34 of the utensil 30 is locked at the first opening 16 of the handle device 10 such that the utensil 30 is not removable from the handle device 30. Further, as shown, the prongs 32 of the utensil 30 are being pulled upward in the direction C so that the handle device 10 grips the utensil 30 until the utensil 30 is snugged in place in the body of the handle device 10 as shown in FIG. 3D. By pulling the prongs 32 in the direction C, the handle portion 34 slides inside the slot 22 towards the first opening 16 until it cannot slide anymore at which point the utensil 30 is firmly secured inside the slot 22 such that the utensil 30 within the handle device 10 will not move even when the pressure is applied on it. As such, the utensil 30 is completely secured in the handle device 10.

Referring to FIG. 3E illustrates a top view of the utensil 30 securely placed inside the handle device 10. As shown, the upper part of the handle portion 34 of the utensil 30 is securely locked at the first opening 16 of the handle device 16. FIG. 3F illustrates a bottom view of the utensil 30 securely placed inside the handle device 10. As shown, the lower part of the handle portion 34 of the utensil 30 with the substantially flat end 30 exits through the second opening.

In another embodiment, FIG. 4A illustrates the handle device 10 with an instrument 40 inserted into the handle device 10. Although, the instrument 40 is shown to be a pencil, one of ordinary skill would appreciate that other instruments such as pens, markers, highlighters, toothbrushes, knitting needles, crochet needles, screw drivers, file handles, heel bars or other instruments and/or tools that have a substantially round handle may be used as the instrument 40 of the present invention. A typical instrument 40 such as the pencil has a sharp end 42 and a handle portion 44 with a substantially round handle. Specifically, the handle portion 44 of the instrument 40 is inserted into the central opening/aperture 18e of the second opening 18 and pushed in the direction of arrow D as shown in FIG. 4A. As such, the instrument 40 is pushed inside the cavity 20 towards the first end 15 of the handle device 10 to tighten the instrument 40. Specifically, the instrument 40 slides inside the slot 22 when the instrument 40 is pushed inside the cavity 20. The instrument 40 gets tighter the more it is pushed inside the cavity 20. in order to firmly secured inside the body of the handle device 10. Accordingly, the handle portion 44 of the instrument 40 is firmly secured within the handle device 10. In one embodiment, the instrument 40 may be removed from the handle device 10 by applying lot of force in pulling the instrument 40 out of the handle device 10 via the opening 18. As shown in FIG. 4B, the handle portion 44 of instrument 40 is securely placed inside the slot 22 in the cavity 20 of the handle device 10.

In a further embodiment, FIG. 5A illustrates the handle device 10 with a utensil 50 inserted into the handle device 10. Although, the utensil 50 is shown to be a knife, one of ordinary skill would appreciate that other utensils such as chopsticks, skewers or other utensils, tools or instruments that have a substantially flat body may be used as the utensil 50 of the present invention. A typical utensil 50 such as the knife has substantially flat body including a substantially flat sharp portion 52 and a substantially flat handle portion 54. In order to attach the utensil 50 to the handle device 10, utensil 50 is aligned with the handle device 10 and the flat sharp portion 52 is inserted into the second opening 18 of the handle device 10 in the direction of arrow E as shown in FIG. 5A. As discussed above, the sides 18b and 18d of the second opening 18 are parallel to the substantially elongated first opening 16. As such, the flat sharp portion 52 is inserted into the second opening 18 via the central aperture 18e and the two sides 18b and 18d. It should be understood that the utensil 50 is inserted into the second opening 18 such that the flat handle portion 54 is placed at the inner surface 14 of the handle device 10 as further described in detail below.

As shown in FIG. 5B, the utensil 50 is inserted and pushed into the handle device 10 such that flat sharp portion 52 of the utensil 50 protrudes from the first opening 16 and the flat handle portion 54 lies within the cavity 20 of the inner surface 14 of the handle device 10. As shown, a lower part of the flat handle portion 52 is positioned adjacent to the second opening 18. As such, the lower part of the flat handle portion 52 is visible from the opening 18 of the second end 17 of the handle device 10. In one embodiment, a force may be applied to the utensil 50 in the direction F as shown in FIG. 5C in order to set the utensil 50 in place of the first opening 16 of the handle device 10. As such, the utensil 50 is securely and firmly placed within the cavity 20 of the inner surface 14 of the handle device 10. Similarly, the force may be applied in a direction opposite to the direction F in order to securely and firmly place the utensil within the cavity 20 of the inner surface 14 of the handle device 10.

It will be appreciated by those skilled in the art that changes could be made to the embodiments described above without departing from the broad inventive concept thereof. It will be understood, therefore, that this invention is not limited to the particular embodiments disclosed, but is intended to cover modifications within the spirit and scope of the present invention as defined by the appended claims.

What is claimed is:

1. A handle device comprising:
a hollow body having an outer surface and an inner surface forming a cavity, wherein a slot is formed within the cavity, wherein an opening is formed at a first end of the body for an insertion of a handle portion of an object, wherein the opening is a modified T-structure of a substantially elongated shape and two tabs located in a center portion of the modified T-structure, wherein the two tabs are substantially perpendicular to the elongated shape of the opening.

2. The handle device of claim 1, wherein the body comprises a second end opposing the first end.

3. The handle device of claim 2, wherein the slot extends from the first end to the second end to provide for placement of the handle portion of the object.

4. The handle device of claim 3, wherein the slot expands when extending from the first end to the second end.

5. The handle device of claim 4, wherein the two tabs function to prevent the object from being removed from the handle device.

6. The handle device of claim 1, wherein the body is made from an elastomeric material, a polymeric material or combination of both materials.

7. The handle device of claim 1,wherein the object is of substantially flat shape.

8. A handle device comprising:
a hollow body having an outer surface and an inner surface forming a cavity, wherein a slot is formed within the cavity, wherein an opening is formed at a first end of the body for an insertion of a handle portion of an object, the opening is a modified star structure comprising a central aperture and four sides of a substantially elongated shape extending from the central aperture.

9. The handle device of claim 8, wherein the body comprises a second end opposing the first end.

10. The handle device of claim 9, wherein the slot extends from the first end to the second end to provide for placement of the handle portion of the object.

11. The handle device of claim 10, wherein the slot expands when extending from the first end to the second end.

12. The handle device of claim 8, wherein the body is made from an elastomeric material, a polymeric material or combination of both materials.

13. The handle device of claim 8, wherein the opening provides for the insertion of an object having a substantially round shape.

14. The handle device of claim 8, wherein the opening provides for the insertion of an object having a substantially flat shape.

15. A handle device comprising:
a hollow body having a first end and a second end opposing the first end, wherein a first opening is formed at the first end and a second opening is formed at the second end, wherein the first opening is a modified T-structure of a substantially elongated shape and two tabs located in a center portion of the modified T-structure, the two tabs are substantially perpendicular to the elongated shape of the opening, wherein the second opening is a modified star structure comprising a central aperture and four sides of a substantially elongated shape extending from the central aperture.

16. The handle device of claim 15, wherein one of the first and the second opening is adapted to receive a handle portion of an object.

17. The handle device of claim 16, wherein a cavity is formed in an inner surface of the body.

18. The handle device of claim 17, wherein a slot is formed within the cavity such that the slot extends from the first end to the second end to provide for placement of the handle portion of the object.

19. The handle device of claim 18, wherein the slot expands when extending from the first end to the second end.

20. The handle device of claim 19, wherein the two tabs function to prevent the object from being removed from the handle device.

21. The handle device of claim 15, wherein the body is made from an elastomeric material, a polymeric material or combination of both materials.

22. The handle device of claim 15, wherein the first opening is adapted to receive an object of substantially flat shape.

23. The handle device of claim 15, wherein the second opening is adapted to receive an object having one of substantially round shape or substantially flat shape.

24. A method of using a handle device, the method comprising:
inserting a handle of an object into an opening formed on a first end of a hollow body of the handle device, wherein the handle having a substantially flat shape, wherein the opening is a modified T-structure of a substantially elongated shape and two tabs located in a center portion of the modified T-structure, wherein the two tabs are substantially perpendicular to the elongated shape of the opening, wherein the body comprises an outer surface and an inner surface forming a cavity, wherein the handle slides into the cavity; and
rotating the object such that upper part of the handle of the object fits securely into the two tabs of the opening.

26. The method of claim 25, wherein a slot is formed in the cavity, wherein the slot extends from the first end to a second end of the body, wherein the handle of the object is securely placed in the slot upon the rotating of the object.

27. The method of claim 26, wherein the object comprising an upper portion and a lower portion, wherein the lower portion having the handle.

28. The method of claim 27 further comprising pulling the upper portion of the object such that the handle slides in the slot towards the first end.

29. A method of using a handle device, the method comprising:
inserting a handle of an object into an opening formed on a first end of a hollow body of the handle device, wherein the opening is a modified star structure comprising a central aperture and four sides of a substantially elongated shape extending from the central aperture wherein the body comprises an outer surface and an inner surface forming a cavity; and
pushing the handle of the object such that the handle slides into the cavity.

30. The method of claim 29, wherein the handle of the object is one of a substantially flat shape or a substantially round shape.
